(19) United States
(12) Patent Application Publication
(10) Pub. No.: US 2009/0294309 A1
(43) Pub. Date: Dec. 3, 2009

(54) APPARATUS AND PROCESS FOR HOLDING AT LEAST TWO CONSUMER GOODS

(76) Inventor: Michael Anthony FRANCO, Long Beach, CA (US)

Correspondence Address: SHELL OIL COMPANY, P O BOX 2463, HOUSTON, TX, 772522463, US

(21) Appl. No.: 12/128,333

(22) Filed: May 28, 2008

(51) Int. Cl. B65D 69/00; A47F 5/08; B23P 19/04

(52) U.S. Cl. 206/223; 211/59.1; 29/700

(57) ABSTRACT

An apparatus and process for holding at least two consumer goods comprising a holder comprising a first surface, a second surface, and an edge between the first surface and the second surface. An apparatus and process for holding at least two consumer goods comprising a holder comprising a surface wherein the surface comprises a first side edge, a second side edge, a proximal end, and a distal end.

### FIELD OF THE INVENTION

The invention relates to an apparatus and process for holding at least two consumer goods.

### BACKGROUND OF THE INVENTION

Retailers need a quick and easy way of loading products, for example, packages of consumer goods, onto peg hooks to maintain appropriate stock levels in the retailers' stores. This is especially important as retailers seek improved cost efficiency to provide better value to their consumers and remain competitive. A current practice is for retailers to take the products out of the bulk shipping unit, for example, a shipping box, one or two at a time and then hang the products on a peg hook located, for example, on a pegboard, or on a wall in a retailer's store, or on a shop keeping unit (SKU). If there are, for example, eight products in a shipping box, this process would have to be repeated four or eight times.

U.S. Pat. No. 3,313,407 relates to a novel carton for storing articles which are to be displayed in a store on suitable hangers such as a pegboard and more particularly to the carton construction for storage and alignment of items displayed in “bubble-pak” or on merchandise display cards with the cards being readily fed and aligned onto a display rack or hanger directly from the carton with a minimum of time and effort.

There is a continuing need for an apparatus and process that will provide for a holding of at least two consumer goods. Further, there is a continuing need for such apparatus and process to provide for increased efficiency when using to hang consumer goods on a peg hook. There is also a continuing need for such apparatus and process to be utilized without the need for removing the peg hook from the peg hook's original position, for example, from a pegboard, or from a wall in a retailer's store, or from a shop keeping unit (SKU).

### SUMMARY OF THE INVENTION

An apparatus for holding at least two consumer goods comprising a holder comprising a first surface, a second surface, and an edge between the first surface and the second surface.

A process comprising contacting an apparatus, for holding at least two consumer goods, comprising a holder comprising a first surface, a second surface, and an edge between the first surface and the second surface, with at least one of the at least two consumer goods such that at least one of the at least two consumer goods remains on the holder.

A process comprising contacting an apparatus, for holding at least two consumer goods, comprising a holder comprising a first surface, a second surface, and an edge between the first surface and the second surface, with at least one of the at least two consumer goods such that at least one of the at least two consumer goods remains on the holder and further comprising containing the at least two consumer goods in a container.

An apparatus for holding at least two consumer goods comprising a holder comprising a surface wherein the surface comprises a first side edge, a second side edge, a proximal end, and a distal end.

A process comprising contacting an apparatus, for holding at least two consumer goods, comprising a holder comprising a surface, wherein the surface comprises a first side edge, a second side edge, a proximal end, and a distal end, and further wherein the surface comprises a shape selected from the group consisting of flat and semi-circular, with at least one of the at least two consumer goods such that at least one of the at least two consumer goods remains on the holder.

A process comprising contacting an apparatus, for holding at least two consumer goods, comprising a holder comprising a surface, wherein the surface comprises a first side edge, a second side edge, a proximal end, and a distal end, and further wherein the surface comprises a shape selected from the group consisting of flat and semi-circular, with at least one of the at least two consumer goods such that at least one of the at least two consumer goods remains on the holder and further comprising containing the at least two consumer goods in a container.

### BRIEF DESCRIPTION OF THE DRAWINGS

For a detailed understanding of embodiments of the present invention, reference is made to the following description of example embodiments, taken in conjunction with the accompanying drawings, in which like elements have been given like numbers, wherein:

FIG. 1 is an isometric view of one embodiment of an apparatus in accordance with the present invention comprising a holder;

FIG. 2 is a top view of the holder of FIG. 1;

FIG. 3 is an end view of the holder of FIG. 1;

FIG. 4 is an isometric view from one side of one embodiment of an apparatus in accordance with the present invention comprising a holder holding four consumer goods partially loaded into a box;

FIG. 5 is an isometric view of the side opposite the view of FIG. 4 of one embodiment of an apparatus in accordance with the present invention comprising a holder holding four consumer goods partially loaded into a box;

FIG. 6 is an isometric view of one embodiment of an apparatus in accordance with the present invention comprising a holder holding four consumer goods loaded into a box;

FIG. 7 is an isometric view of one embodiment of the box of FIG. 6 after the flaps have been closed and a tearstrip partially torn;

FIG. 8 is an isometric view of one embodiment of the box of FIG. 7 after the tearstrip has been completely torn and the lid removed providing for one embodiment of an apparatus in accordance with the present invention comprising a container containing a holder holding four consumer goods;

FIG. 9 is an isometric view of one embodiment of an apparatus in accordance with the present invention comprising the container and holder of FIG. 8 holding four consumer goods after the holder has been placed on a peg hook;

FIG. 10 is an isometric view of one embodiment of an apparatus in accordance with the present invention comprising a holder holding four consumer goods after the holder has been placed on a peg hook without the use of the container of FIG. 8;

FIG. 11 is an isometric view of one embodiment of removing an apparatus, in accordance with the present invention comprising a holder, from the peg hook of FIG. 9 leaving the four consumer goods on the peg hook;

FIG. 12 is an isometric view of the four consumer goods of FIG. 11 remaining on the peg hook after removing the holder;

FIG. 13 is an isometric view of another embodiment of an apparatus in accordance with the present invention comprising a holder;

FIG. 14 is an isometric view of another embodiment of an apparatus in accordance with the present invention comprising a holder;

FIG. 15 is an isometric view of one embodiment of an apparatus in accordance with the present invention comprising a holder in an example embodiment of a hole of a consumer good package;

FIG. 16 is an isometric view of one embodiment of an apparatus in accordance with the present invention comprising a holder in another example embodiment of a hole of a consumer good package;

FIG. 17 is an isometric view of another embodiment of an apparatus in accordance with the present invention comprising a holder in an example embodiment of a hole of a consumer good package;

FIG. 18 is an isometric view of another embodiment of an apparatus in accordance with the present invention comprising a holder in another example embodiment of a hole of a consumer good package;

FIG. 19 is an isometric view of another embodiment of an apparatus in accordance with the present invention comprising a holder in an example embodiment of a hole of a consumer good package;

FIG. 20 is an isometric view of another embodiment of an apparatus in accordance with the present invention comprising a holder in another example embodiment of a hole of a consumer good package;

FIG. 21 is an isometric view of another embodiment of an apparatus in accordance with the present invention comprising a holder; and

FIG. 22 is an end view of the holder of FIG. 21.

### DETAILED DESCRIPTION OF THE INVENTION

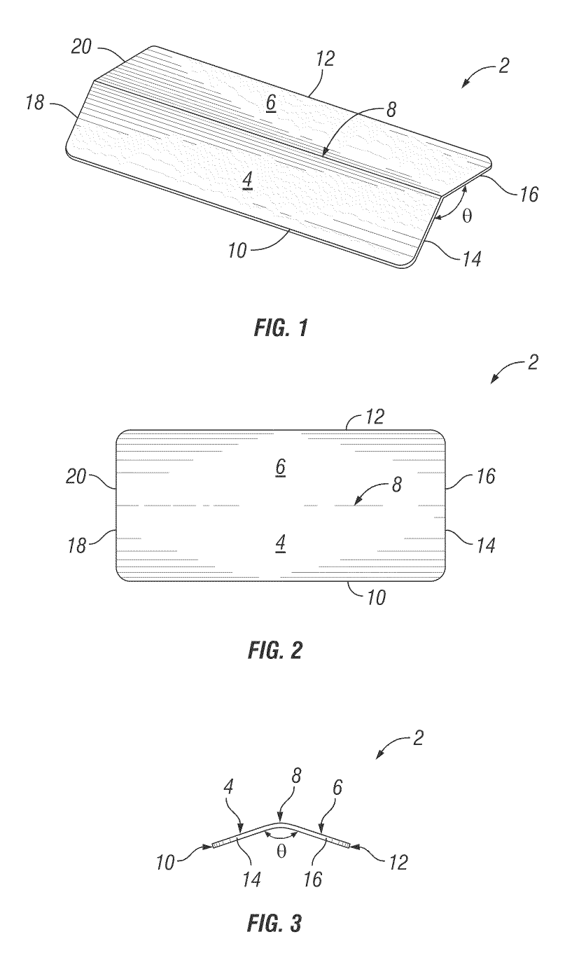

Referring to FIGS. 1-3, one embodiment of a holder in accordance with the present invention, holder 2, comprises a first surface 4 and a second surface 6. Surfaces 4 and 6 are preferably inclined with respect to one another and are preferably of substantially equal length and width. Surfaces 4,6 are generally rectangular in shape. Surfaces 4 and 6 are generally mirror-images of each other. An edge 8 defines the intersection of surfaces 4, 6. Surface 4 includes a first side edge 10, a first proximal end 14, and a first distal end 18. Similarly, surface 6 includes a second side edge 12, a second proximal end 16, and a second distal end 20. An angle theta (θ) between surfaces 4 and 6 should be such that holder 2 can pass through the holes of packaging of consumer goods as described below.

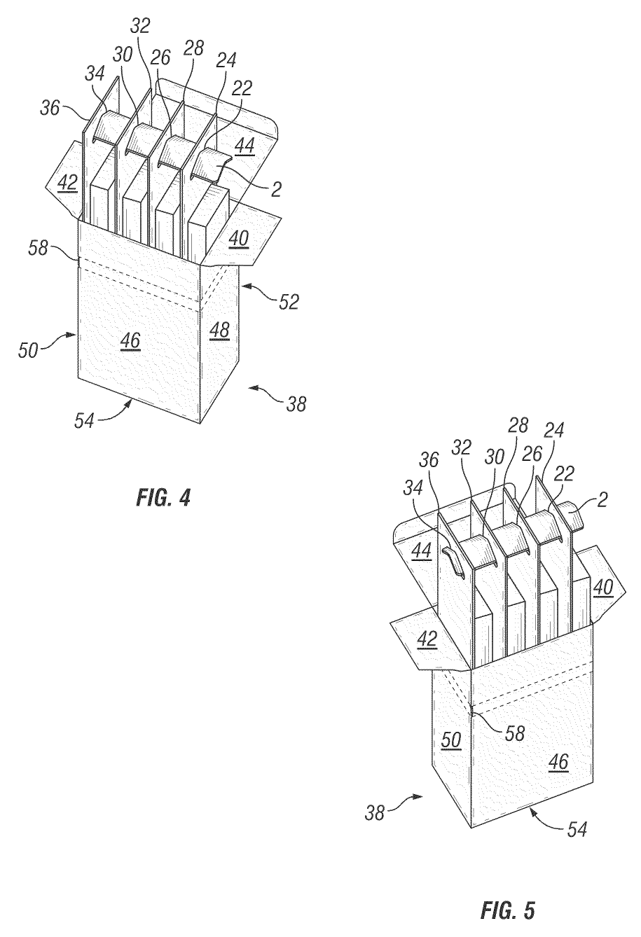

Referring to FIG. 4, holder 2 is shown after contacting holder 2 with at least one of at least two consumer goods, for example, after passing holder 2 through holes 22, 26, 30, 34 of consumer good packages 24, 28, 32, 36, respectively. It should be understood that while four consumer good packages are shown, any number of consumer good packages could be utilized as long as such number is at least two. The phrase “consumer goods” as referred to herein includes consumer goods that do not have packaging, consumer goods that do have packaging (also referred to as “consumer good packages”), and combinations thereof. Examples of consumer goods that do not have packaging include key chains and small toys. Examples of consumer goods that have packaging include air fresheners and various after-market auto accessories. Consumer good packages 24, 28, 32, 36 are shown partially loaded into box 38.

Still referring to FIG. 4, box 38 includes a first edge flap 40, a second edge flap 42, and a lid flap 44. Box 38 further includes a front side 46, a right side 48, a left side 50, a back side 52, and a bottom 54. It should be understood that bottom 54 may comprise edge flaps and a lid flap similar to the top portion of box 38 or may comprise one single section similar to the sides of box 38. Box 38 further includes a means for separating. Examples of suitable means for separating include any means that provides for a separating of a box, for example, box 38, into a lid and a container as described below. Examples of suitable means for separating include a tearstrip and a perforation. An example of a perforation includes a perforated box. When a tearstrip is utilized, for example, tearstrip 58, the tearstrip may be flush with an edge of the box, as shown for example in FIG. 4, or may have a tearstrip hole near an end of the tearstrip, that provides for a contacting of tearstrip 58, for example, with a user, so tearstrip 58 can be removed as discussed below.

Any box and means for separating as known to those skilled in the art may be used. However, as described below, when a box, for example, box 38, and a means for separating, for example, tearstrip 58, are utilized in accordance with the present invention, a container is provided that is used in a novel and inventive manner as part of an apparatus and process of the present invention.

Referring to FIG. 5, an example embodiment of the present invention is shown that is generally a view from the opposite side and angle from that shown in FIG. 4.

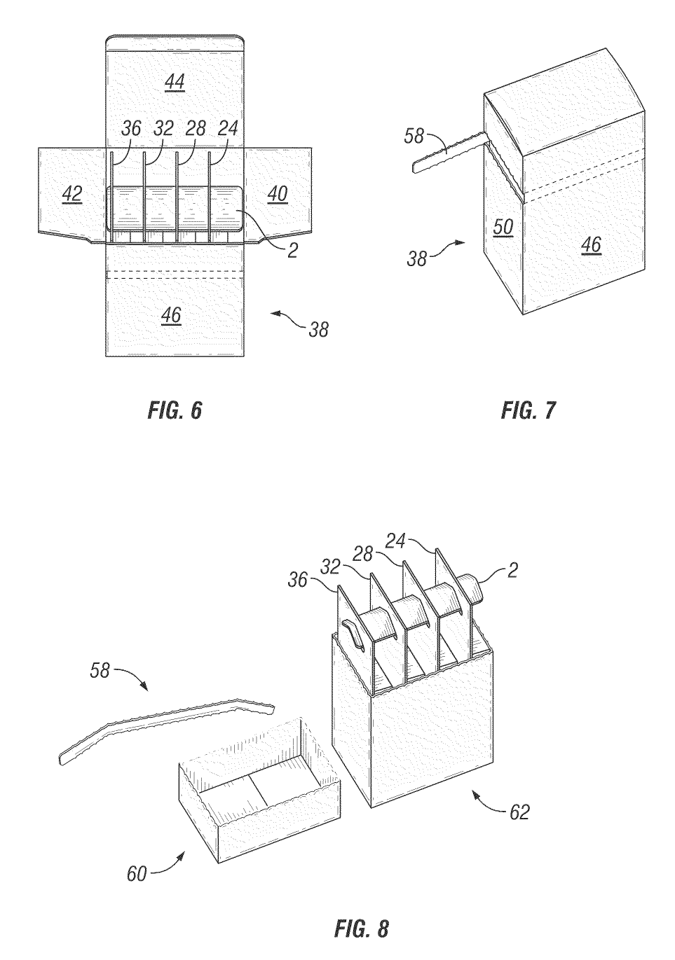

Referring to FIG. 6, an example embodiment of the present invention is shown after holder 2 and consumer good packages 24, 28, 32, 36 have been loaded into box 38.

Referring to FIG. 7, box 38 is shown at a similar view and angle as FIG. 5 and is shown after holder 2 and consumer good packages 24, 28, 32, 36 have been loaded into box 38, and also after first edge flap 40, second edge flap 42, and lid flap 44 have been closed, for example when box 38 has been loaded and ready for shipping. FIG. 7 also shows tearstrip 58 having been partially torn from box 38.

Referring to FIG. 8, box 38 is shown after tearstrip 58 has been completely torn from box 38 providing for a lid 60 and a container 62. Lid 60 includes first edge flap 40, second edge flap 42, and lid flap 44 as well as the upper portions of box 38 including front side 46, right side 48, left side 50, and back side 52. Container 62 includes lower portions of box 38 including front side 46, right side 48, left side 50, back side 52, and bottom 54. FIG. 8 also shows holder 2 and the upper portions of consumer good packages 24, 28, 32, 36.

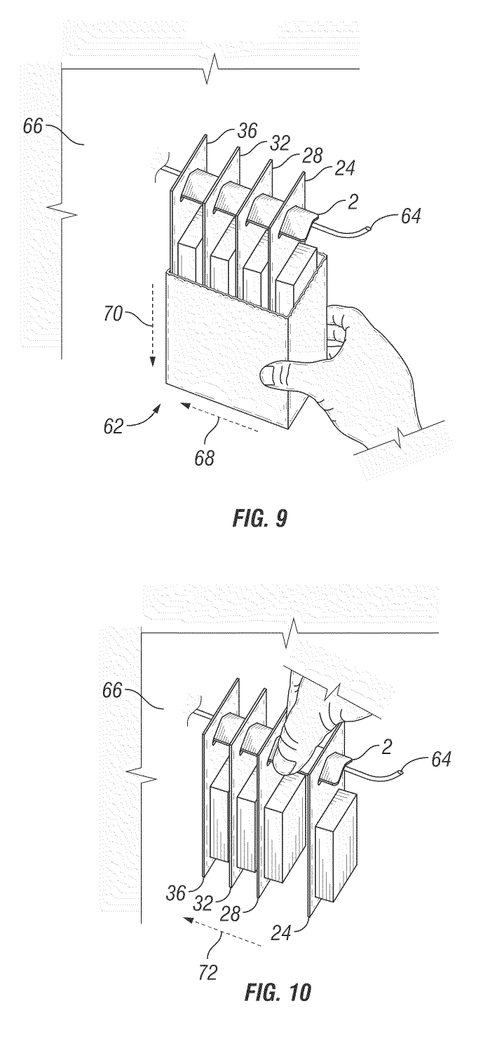

Referring to FIG. 9, an example apparatus and process of the present invention is shown that may be utilized when there is enough space among the peg hooks to accommodate container 62. Referring to FIG. 9, container 62 is shown after container 62 has been moved in a general direction 68 towards peg hook 64 of wall 66. Container 62 is moved towards peg hook 64 in a manner that provides for peg hook 64 to run underneath holder 2 and through holes 22, 26, 30, 34 of consumer good packages 24, 28, 32, 36, respectively. Container 62 can then be moved in a general direction 70 to remove container 62 leaving holder 2 and consumer good packages 24, 28, 32, 36 hanging on peg hook 64. When an apparatus and process of the present invention comprises holder 2 and container 62, holder 2 may provide a benefit of helping to maintain an alignment of holes 22, 26, 30, 34 of consumer good packages 24, 28, 32, 36, respectively, that may increase the speed and efficiency at which such consumer good packages may be loaded onto one or more peg hooks 64. For example, instead of having to align each individual hole with peg hook 64, one can focus on ensuring that distal ends 18, 20 of holder 2 are slightly above or even in slight contact with peg hook 64 providing for holder 2 to slide over or onto peg hook 64 without the need to align each individual hole. While FIG. 9 shows one peg hook 64, it should be understood that wall 66 may contain numerous peg hooks 64, for example, as in a store or on a shop keeping unit (SKU).

Referring to FIG. 10, an example embodiment is shown when container 62 is not utilized to place the consumer good packages on a peg hook, for example, when there is not enough room among the peg hooks to accommodate the size of the container. FIG. 10 shows holder 2 with consumer good packages 24, 28, 32, 36 thereon after removing from container 62. When in use, for example, a user can contact surfaces 4, 6 of holder 2, side edges 10, 12 of holder 2, or a combination thereof, for example, by grabbing with a hand, and lifting holder 2 from container 62 and moving in a general direction 72 towards peg hook 64 of wall 66.

It should be understood that when holder 2 is removed from, for example, lifted from, container 62, holder 2 can be contacted at any position along holder 2 as long as holder 2 can be removed from, for example, lifted from, container 62 and placed on peg hook 64 as described herein. For example, a user can contact first surface 4, second surface 6, first side edge 10, second side edge 12, and combinations thereof, at a location between consumer good package 24 and 28, or at a location between consumer good package 28 and 32, or at a location between consumer good package 32 and 36. Also for example, a user can contact first surface 4, second surface 6, first side edge 10, second side edge 12, first proximal end 14, second proximal end 16, first distal end 18, second distal end 20, and combinations thereof for removing holder 2 from, for example, lifting holder 2 from, container 62 and placing on peg hook 64 as described herein. Combinations of locations of contacting are also possible, for example, when using two hands to lift holder 2 from container 62.

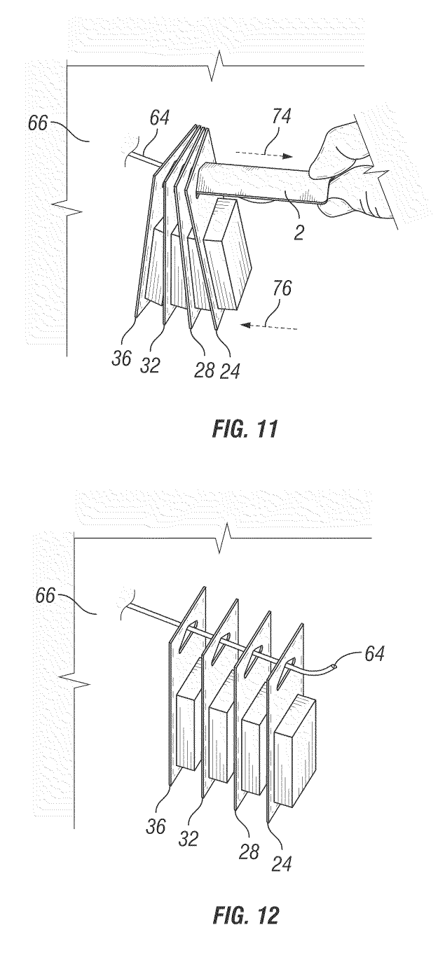

Referring to FIG. 11, holder 2 is shown after moving holder 2 in a general direction 74 providing for a removing of holder 2 from peg hook 64 of wall 66 while consumer good packages 24, 28, 32, 36 remain on peg hook 64. For example, holder 2 can be moved in general direction 74 with a slight uplifting of holder 2 that provides for the removing of holder 2 from peg hook 64 while consumer good packages 24, 28, 32, 36 remain on peg hook 64. In addition, if additional force is needed to remove holder 2, force may be applied, for example, with the hand of a user, in a general direction 76 to help in the removing of holder 2 and the maintaining of consumer good packages 24, 28, 32, 36 on peg hook 64. For example, as more consumer good packages are located on the holder, such consumer good packages may exert more downward pressure on the holder compared to two or four consumer good packages on the holder. Thus, more force may be needed in directions 74 and 76 to remove holder 2 while maintaining the consumer good packages on peg hook 64.

Also for example, when container 62 is utilized, holder 2 may be removed as described herein with reference to FIG. 11 before or after removing container 62 as described herein with reference to FIG. 9.

Referring to FIG. 12, consumer good packages 24, 28, 32, 36 are shown on peg hook 64 of wall 66 after holder 2 has been removed and, when utilized, after container 62 has been removed.

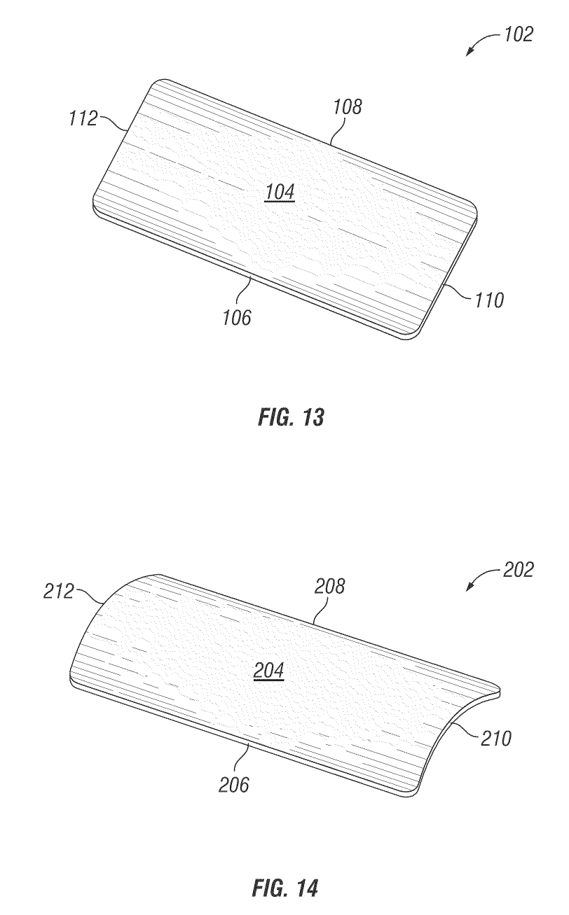

Referring to FIG. 13, another embodiment of a holder in accordance with the present invention, holder 102, comprises a surface 104. Surface 104 is generally flat in shape. Surface 104 is also generally rectangular in shape. Surface 104 includes a first side edge 106, a second side edge 108, a proximal end 110, and a distal end 112.

Referring to FIG. 14, another embodiment of a holder in accordance with the present invention, holder 202, comprises a surface 204. Surface 204 is generally semi-circular in shape. Surface 204 is also generally rectangular in shape. Surface 204 includes a first side edge 206, a second side edge 208, a proximal end 210, and a distal end 212.

As described herein, examples of a suitable shape of a surface of a holder in accordance with the present invention include flat and semi-circular. It should be understood that the shape of a surface of a holder in accordance with the present invention can be any shape that provides for a holding of at least two consumer goods as described herein.

Holder 102 and holder 202 can be contacted and utilized in a manner similar to the contacting and utilizing of holder 2 as described herein. An example of contacting includes contacting a holder with at least one of at least two consumer goods. Another example of contacting includes a user contacting a holder. For example, when utilizing holder 102, a user can contact surface 104, first side edge 106, second side edge 108, proximal end 110, distal end 112, and combinations thereof for removing holder 102 from, for example, lifting holder 102 from, container 62 and placing on peg hook 64 as described herein with reference to holder 2. Combinations of locations of contacting are also possible, for example, when using two hands to lift holder 102 from container 62. Also for example, when utilizing holder 202, a user can contact surface 204, first side edge 206, second side edge 208, proximal end 210, distal end 212, and combinations thereof for removing holder 202 from, for example, lifting holder 202 from, container 62 and placing on peg hook 64 as described herein with reference to holder 2. Combinations of locations of contacting are also possible, for example, when using two hands to lift holder 202 from container 62.

Also for example, as described herein with reference to holder 2, when container 62 is utilized, holder 102 may be removed as described herein with reference to FIG. 11 before or after removing container 62 as described herein with reference to FIG. 9. Also for example, as described herein with reference to holder 2, when container 62 is utilized, holder 202 may be removed as described herein with reference to FIG. 11 before or after removing container 62 as described herein with reference to FIG. 9.

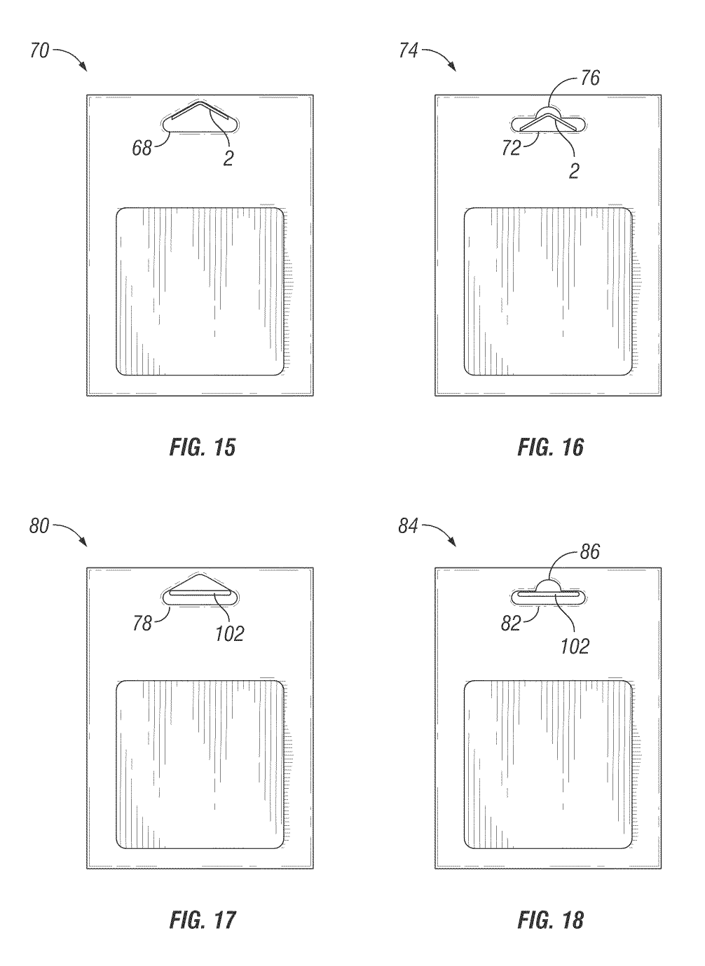

Referring to FIG. 15, an isometric view of an example embodiment of a holder in accordance with the present invention, holder 2, is shown in a hole 68 of a consumer good package 70. Hole 68 is generally triangular in shape. The value of angle theta and the width of surfaces 4, 6 is such that edge 8 generally contacts the top of hole 68 and surfaces 4, 6 generally contact the left and right sides of hole 68, respectively.

Referring to FIG. 16, an isometric view of an example embodiment of a holder in accordance with the present invention, holder 2, is shown in a hole 72 of a consumer good package 74. Hole 72 is generally oval in shape with a small notch 76 at the top middle of the oval. The value of angle theta and the width of surfaces 4, 6 is such that edge 8 is generally located near notch 76 and the edges 10, 12 of surfaces 4, 6 are generally located near the left and right of hole 72, respectively.

Referring to FIG. 17, an isometric view of another example embodiment of a holder in accordance with the present invention, holder 102, having a flat shape is shown in a hole 78 of a consumer good package 80. Hole 78 is generally triangular in shape. The width of surface 104 is such that edges 106, 108 of surface 104 generally contact the left side and right side of hole 78, respectively.

Referring to FIG. 18, an isometric view of another example embodiment of a holder in accordance with the present invention, holder 102, having a flat shape is shown in a hole 82 of a consumer good package 84. Hole 82 is generally oval in shape with a small notch 86 at the top middle of the oval. The width of surface 104 is such that portions of surface 104 generally contact the left and right of hole 82. The width of surface 104 is also such that first side edge 106 and second side edge 108 are generally located near the left and right of hole 82, respectively.

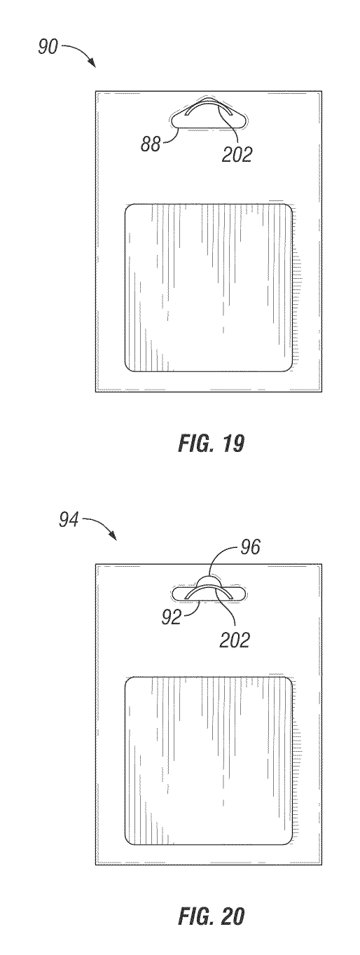

Referring to FIG. 19, an isometric view of another example embodiment of a holder in accordance with the present invention, holder 202, having a semi-circular shape is shown in a hole 88 of a consumer good package 90. Hole 88 is generally triangular in shape. The width of surface 204 is such that portions of surface 204 generally contact the left and right of hole 88. The width of surface 204 is also such that first side edge 206 and second side edge 208 are generally located near the left and right of hole 88, respectively.

Referring to FIG. 20, an isometric view of another example embodiment of a holder in accordance with the present invention, holder 202, having a semi-circular shape is shown in a hole 92 of a consumer good package 94. Hole 92 is generally oval in shape with a small notch 96 at the top middle of the oval. The width of surface 204 is such that portions of surface 204 generally contact the left and right of hole 92. The width of surface 204 is also such that first side edge 206 and second side edge 208 are generally located near the left and right of hole 92, respectively.

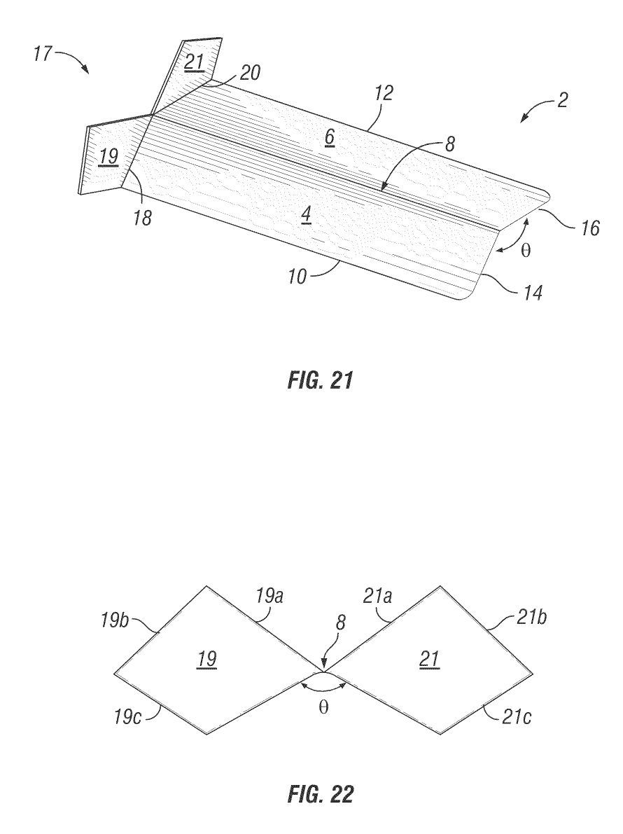

Referring to FIGS. 21-22, another example embodiment of a holder in accordance with the present invention, holder 2, includes a means for retaining 17 at least one of at least two consumer goods. The location of retaining means 17 on holder 2 can be any location as long as such location provides for at least one of the at least two consumer goods to be retained on holder 2, for example, on surfaces 4, 6. Examples of suitable locations of retaining means 17 include at first distal end 18, at second distal end 20, at first proximal end 14, at second proximal end 16, and combinations thereof. A preferred location of retaining means 17 is at first distal end 18 and at second distal end 20. Retaining means 17 could also be located at several points along surfaces 4, 6. Retaining means 17 generally provides for a winged-shape portion on holder 2. Retaining means 17 is shown comprising a wing 19 and a wing 21. Wing 19 is generally in the shape of a trapezoid having a first edge 19a, a second edge 19b, and a third edge 19c. Similarly, wing 21 is generally in the shape of trapezoid having a first edge 21a, a second edge 21b, and a third edge 21c.

The means for retaining, for example, retaining means 17, can be any means for retaining as long as such means provides for at least one of at least two consumer goods to be retained on a holder in accordance with the present invention, for example, on one or more surfaces of the holder, for example, on surfaces 4, 6 of holder 2, on surface 104 of holder 102, and on surface 204 of holder 202. The means for retaining, for example, retaining means 17, can be any size and shape as long as such means can be utilized in accordance with the present invention and provides for at least one of at least two consumer goods to be retained on a holder in accordance with the present invention, for example, on one or more surfaces of the holder, for example, on surfaces 4, 6 of holder 2, on surface 104 of holder 102, and on surface 204 of holder 202. Examples of suitable shapes of a means for retaining include squares, circles, rectangles, triangles, trapezoids, and combinations thereof.

It should be understood that the consumer good package(s) nearest a retaining means will be in general contact with the retaining means that may be constant or intermittent. For example, if a holder in accordance with the present invention is tilted at an angle, that is, generally not horizontal, depending on the location and number of the retaining means, one or more consumer good packages may be in constant or intermittent contact with the retaining means.

When a means for retaining in accordance with the present invention, for example, retaining means 17, is at distal ends 18, 20 of holder 2, holder 2 can be tilted slightly downward towards distal ends 18, 20 providing for consumer good package 36 to contact retaining means 17 and also providing for the other consumer good packages 24, 28, and 32 to contact each other that provides for the consumer good packages to stay on the holder. Also for example, in a similar manner, when retaining means 17 is at proximal ends 14, 16 of holder 2, holder 2 can be tilted slightly downward towards proximal ends 14, 16 providing for consumer good package 24 to contact retaining means 17 and also providing for the other consumer good packages 28, 32, 36 to contact each other that provides for the consumer good packages to stay on the holder.

A holder in accordance with the present invention may be manufactured from any suitable material including, for example, cardboard, plastic, metal, and combinations thereof. Examples of suitable cardboard include B33 cardboard and KRAFT die cut corrugated strip. Examples of suitable plastic include polypropylenes, polyethylenes, polycarbonates, nylons, polyvinylcarbonates, and polyurethanes. A container in accordance with the present invention, for example, container 62, may be manufactured from any suitable material including, for example, cardboard, plastic, metal, and combinations thereof.

A holder in accordance with the present invention can be any length, width, and thickness that suitably provides for an apparatus and process of the present invention. The length generally depends on, for example, the number of consumer good packages and the thickness of each consumer good package, for example, the thickness of the bubble-pak that contains the consumer good. For example, the length of a holder for four consumer good packages may be less than the length of a holder for eight consumer good packages.

The width generally depends on the size and shape of the hole of the consumer good package, for example, as described above with reference to FIGS. 15-20. For example, the width may be generally enough to keep the consumer good packages from significantly moving, for example, from significantly sliding, while the consumer good packages are on the holder, yet allows the holder to be removed from the consumer good packages after contact of the holder with the peg hook as described herein.

The thickness generally depends on what type of material is utilized to provide for a holder in accordance with the present invention. For example, if cardboard is utilized, such cardboard may need to be thicker than, for example plastic or metal.

A holder in accordance with the present invention may be manufactured using any method that suitably provides for an apparatus and process of the present invention. For example, if cardboard is utilized, a holder in accordance with the present invention may be manufactured using machinery utilized in preparing cardboard. For example, a B33 cardboard may be die cut and then an edge, for example, edge 8, may be provided by folding. Also for example, a KRAFT die cut corrugated strip may be utilized to provide for a holder in accordance with the present invention and the strip may be creased lengthwise at the midpoint in the longitudinal direction during production to provide for an edge, for example, edge 8. Also for example, if thermoplastic is utilized, a holder in accordance with the present invention may be manufactured using injection molding or vacuum forming. For example, a polypropylene plastic sheet having a 1 millimeter (mm) thickness may be die cut with a perforated strip in the center and then folded. Determining the appropriate material and method of manufacturing for providing for a holder in accordance with the present invention is within the skill in the art. Similarly, determining the appropriate material and method of manufacturing for providing for a container in accordance with the present invention, for example, container 62, is within the skill in the art.

An example holder 2 for use with four consumer good packages, for example, four air fresheners, can be made of B33 cardboard that is die cut and folded by hand. The length can be 4.75 inches (120.65 mm), the width can be 1.5 inches (38.1 mm), and the thickness can be 0.07 inches (1.778 mm).

Another example holder 2 for use with four consumer good packages, for example, four air fresheners, can be made of KRAFT die cut corrugated strip and the strip can be creased lengthwise at the midpoint in the longitudinal direction during production. The length can be 5.25 inches (133.35 mm), the width can be 40 mm (1.57 inches), and the thickness can be 1.95 mm (0.077 inches). Also, for example, the differences in dimensions between the two example holders 2 for four consumer good packages may be attributed to the differences in thicknesses of the four consumer good packages. For example, as the thickness of each consumer good package increases, the length of the holder may need to increase. Also, for example, consumer good packages of various thicknesses may be utilized with the same holder.

From the above two example holders 2 for use with four consumer good packages, examples of ranges of lengths for a holder in accordance with the present invention for use with four consumer good packages may include, for example, generally 80 mm to 180 mm, preferably 100 mm to 160 mm, and more preferably 120 mm to 140 mm. From the above two example holders 2 for use with four consumer good packages, examples of ranges of widths for a holder in accordance with the present invention for use with four consumer good packages may include, for example, generally 25 mm to 55 mm, preferably 30 mm to 50 mm, and more preferably 35 mm to 45 mm. From the above two example holders 2 for use with four consumer good packages, examples of ranges of thicknesses for a holder in accordance with the present invention for use with four consumer good packages may include, for example, generally 0.50 mm to 2.50 mm, preferably 0.75 mm to 2.25 mm, and more preferably 1 mm to 2 mm.

A potential benefit of an embodiment of the present invention is that a holder in accordance with the present invention may be utilized again as a holder after removing from a peg hook. While a holder in accordance with the present invention has been shown herein as a part of a pre-package before loading into a box, it should be understood that a holder in accordance with the present invention could be utilized after the lid has been removed. For example, a holder in accordance with the present invention could be slid through the holes of the consumer good packages before contacting the holder with the peg hook, for example, before placing the holder on the peg hook.

The foregoing description is intended as a means of illustration and should not be construed as limiting the scope of the invention in any way. Those skilled in the art will recognize many variations that may be made without departing from the spirit of the disclosed invention.

What is claimed is:

1. An apparatus for holding at least two consumer goods comprising a holder comprising a first surface, a second surface, and an edge between the first surface and the second surface.

2. The apparatus of claim 1 wherein the first surface comprises a first side edge, a first proximal end, and a first distal end and further wherein the second surface comprises a second side edge, a second proximal end, and a second distal end.

3. The apparatus of claim 1 wherein the holder comprises a material selected from the group consisting of cardboard, plastic, metal, and combinations thereof.

4. The apparatus of claim 1 further comprising a container for containing the at least two consumer goods.

5. The apparatus of claim 4 wherein the container is provided by a box comprising a means for separating wherein the means for separating has been utilized to provide for a lid and the container.

6. A process comprising contacting an apparatus, for holding at least two consumer goods, comprising a holder comprising a first surface, a second surface, and an edge between the first surface and the second surface, with at least one of the at least two consumer goods such that at least one of the at least two consumer goods remains on the holder.

7. The process of claim 6 further comprising contacting the holder with a peg hook and removing the holder such that the at least two consumer goods remain on the peg hook.

8. A process comprising contacting an apparatus, for holding at least two consumer goods, comprising a holder comprising a first surface, a second surface, and an edge between the first surface and the second surface, with at least one of the at least two consumer goods such that at least one of the at least two consumer goods remains on the holder and further comprising containing the at least two consumer goods in a container.

9. The process of claim 8 further comprising locating the container containing the at least two consumer goods at a location proximate a peg hook such that the holder contacts the peg hook, removing the container such that the holder and the at least two consumer goods remain on the peg hook, and removing the holder such that the at least two consumer goods remain on the peg hook.

10. The process of claim 8 further comprising locating the container containing the at least two consumer goods at a location proximate a peg hook such that the holder contacts the peg hook, removing the holder such that the at least two consumer goods remain on the peg hook, and removing the container such that the at least two consumer goods remain on the peg hook.
